(19) United States
(12) Patent Application Publication
(10) Pub. No.: US 2008/0255875 A1
(43) Pub. Date: Oct. 16, 2008

(54) Systems and Methods for Managing Patient Preference Data

(75) Inventor: Pallav Sharda, Palatine, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/735,818

(22) Filed: Apr. 16, 2007

(51) Int. Cl. G06Q 50/00

(52) U.S. Cl. 705/2

(57) ABSTRACT

Certain embodiments of the present invention provide a method of managing patient preference data comprising: presenting questions to a patient; receiving responses from the patient wherein the responses indicate a preference of the patient; and recording the responses to a repository. Other embodiments provide a system for managing patient preference data comprising: an interactive patient module adapted to receive patient preference data from a patient; and a patient preference data repository adapted to record the patient preference data. Yet other embodiments provide a computer-readable medium having a set of instructions for execution by a computer, the set of instruction comprising: a questioning routine configured to obtain patient preference information from a patient; a recording routine configured to record the patient preference information to the patient's medical records.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Generally, the technical field involves healthcare information systems. Specifically, it involves healthcare information systems for managing patient preference data.

Traditionally, decision making about patient care has been mostly based on the healthcare provider's assumptions about what was in a patient's best interest. However, studies have demonstrated that clinical outcomes perceived as excellent by healthcare professionals may not necessarily be experienced in the same way by patients. That is, while a physician may view the outcome as excellent, patients do not always agree, based on their personal care preference and quality of life expectations. This is particularly true with chronic disease management, and geriatric and palliative care where treatment is complicated and needs to be balanced with patient's preferences for quality of life, treatment alternatives, self-care needs, pain threshold, and social life expectations, for example.

Recently, in order to better suit a patient's needs, there has been increased emphasis on shared decision making between healthcare providers and patients. This change in the system creates a desire for different types of information during the decision making process. Under this new approach, the patient-provided information has created a desire for different types of information system functionalities.

Over the years, healthcare information systems have become more efficient in capturing comprehensive data from the provider's perspective. However, current healthcare information systems do not provide support to assist providers in eliciting patient preferences and integrating them into care decisions.

At best, current systems merely encourage communication between the patient and caregiver. They do not integrate the patient's preferences into medical records or analyze the patient's preferences when making treatment determinations. Also, current systems do not assist the caregiver in analyzing the patient's preferences or answers to determine the proper type of care or treatment. In addition, current systems do not provide a high-level picture of the patient's preferences and needs to a provider.

Accordingly, there is a desire for healthcare information systems for managing patient preference data.

### BRIEF SUMMARY OF THE INVENTION

Certain embodiments of the present invention provide systems and methods for managing patient preference data.

Certain embodiments of the present method of managing patient preference data comprise: presenting questions to a patient; receiving responses from the patient wherein the responses indicate a preference of the patient; and recording the responses to a repository. These steps can be performed sequentially, in some other order or simultaneously.

Another embodiment further includes integrating the responses that are applicable to a certain user into a specific healthcare information system utilized by that user. For example, the certain user may be a nurse and the specific healthcare information system may generate nursing care plans. In another example, the certain care provider may be a physician and the specific healthcare information system may generate physician's orders.

Another embodiment further includes analyzing the responses with data from a healthcare information system. The responses may be analyzed to determine whether treatment based at least in part on patient preferences results in better clinical outcomes. In yet another example, the responses may be analyzed to report data about a certain care provider's performance and patient satisfaction with the care provider's treatment.

The patient's responses can be captured before the patient arrives at the healthcare facility for treatment, during the patient's treatment, and/or after the patient's treatment.

An embodiment of the system for managing patient preference data comprises: an interactive patient module adapted to receive patient preference data from a patient; and a patient preference data repository adapted to record the patient preference data.

The patient preference data can also be integrated into a healthcare information system along with other healthcare data from the healthcare information system.

The patient preference data can also be analyzed with healthcare data from the healthcare information system. The analyzed data can be utilized to provide individualized care.

Examples of the interactive patient module include a website or a computing device connected over a network to a healthcare information system.

Another embodiment of the present disclosure is a computer-readable medium having a set of instructions for execution by a computer, the set of instruction comprising: a questioning routine configured to obtain patient information from a patient; a recording routine configured to record the patient information to the patient's medical records.

The computer-readable medium can have further instructions for an integration routine configured to integrate the patient information with data from at least one healthcare information system.

The computer readable medium can have further instructions for an analysis routine configured to analyze the patient information with data from at least one healthcare information system.

These and other features of the present invention are discussed or apparent in the following detailed description.

### BRIEF DESCRIPTION OF SEVERAL VIEWS OF THE DRAWINGS

FIG. 1 illustrates a system for managing patient preference data according to an embodiment of the present invention.

FIG. 2 illustrates a system for managing patient preference data according to an embodiment of the present invention.

FIG. 3 illustrates a flow diagram for a method for managing patient preference data according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The current disclosure relates to healthcare information systems and methods for managing patient preference data. Although certain particulars of a healthcare information system are used as examples, the current disclosure should not be viewed as limited to such systems.

Nursing practices have always emphasized the importance of patients' perspectives, values and preferences in care planning. However, current healthcare information systems do not provide support in eliciting patient preferences and integrating them into care decisions. The proposed system completes the loop between the patient, the provider and the medical record system. When information about patients' preferences is shared with physicians through medical records and information technology systems, it results in earlier treatment decisions. This in turn leads to reductions in length of time spent in undesirable states.

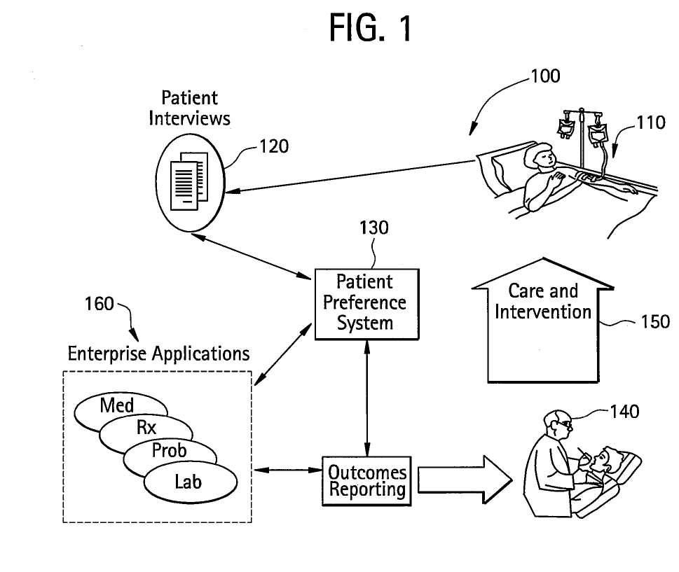

FIG. 1 illustrates a system (100) for managing patient preference data according to an embodiment of the present invention. In system (100) a patient (110) is interviewed (120) regarding his or her treatment and care preferences. The patient's responses enter into a patient preference system (130) where they are recorded. The patient's preferences can then be accessed directly by the provider (140) allowing him or her to offer more individualized care or intervention (150). In another embodiment, the patient preference system (130) interacts with healthcare enterprise applications and/or information systems (160). These applications and/or systems (160) could include pharmacy, medication, problem and laboratory systems, for example. Data from these applications and/or systems (160) may be used by the patient preference system (130). Both the preference data and the data from the healthcare enterprise applications and/or information systems (160) can then be used by the provider (140) to offer more individualized care and/or intervention (150).

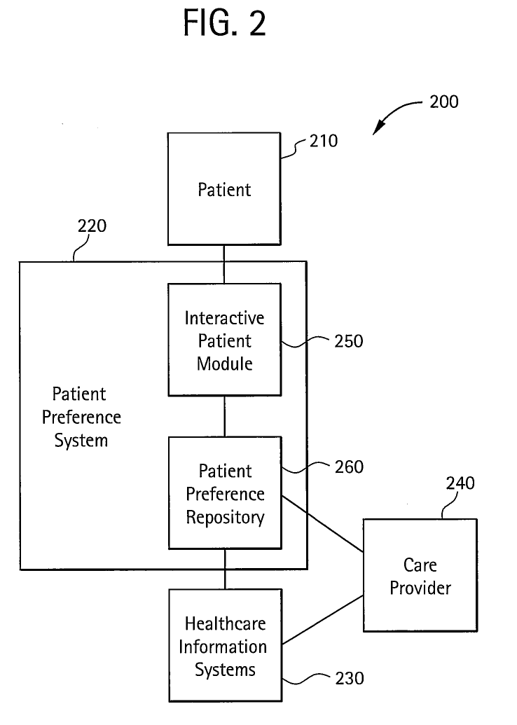

FIG. 2 illustrates a system (200) for managing patient preference data according to an embodiment of the present invention. One embodiment of the present system (200) includes a patient (210), a patient preference system (220), at least one healthcare information system (230) and a care provider (240). The patient preference system is made up of an interactive patient module (250), a patient preference data repository (260). The interactive patient module (250) is in communication with the patient preference data repository (260). The patient preference data repository (260) is in communication with the healthcare information system(s) (230).

The components of the system (200) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain components may be integrated in various forms and/or may be provided as software and/or other functionality on a computing device, such as a computer. Certain embodiments may omit one or more of the components of the system (200).

In operation, the interactive patient module (250) elicits patient care preferences. It allows the patient (210) to enter a data input stream. Possible patient preferences include those related to patient care, quality of life, self-care capabilities, personal beliefs, and pain threshold, for example. Other patient preference data can also be entered with the patient preferences. The patient (210) data can include health history, personal information, and contact information, for example. The patient preferences and other patient data can then be used to offer more effective and preferred treatment to the patient.

The interactive patient module (250) presents various questions to the patient (210). The questions could be presented to the patient (210) in a number of different ways. Possible methods of presenting the questions include direct questions by a caregiver who enters them into the system, a written questionnaire to be entered into the system by the caregiver, a specialized website, a desktop, laptop or handheld computing device that is connected over a network to the healthcare information system, or a home computer using specialized software from the hospital, for example.

Many different forms of questions could be used. Possible question forms include short answer, fill in the blank, yes/no, true/false, multiple choice, Likert scale (a type of response scale used in survey research where respondents specify their level of agreement to a statement), or visual-analog scale (a scale using a line on which patients indicate a level of pain with one end representing no pain and the other end representing extreme pain). Standardized questions from the American Cancer Society could be used, for example.

The questions to the patient (210) could be presented to the patient (210) at a variety of different points during treatment or even at multiple times during the course of treatment. For example, questions could be presented prior arriving at the healthcare facility, upon checking in, within a short time of checking in, upon checkout or when the patient returns for follow up appointments.

The patient (210) could input his or her answers using an input device, such as a keyboard, a touchscreen, a joystick, a mouse, a touchpad, and/or a microphone.

There can also be other data streams into the patient preference system (220) in addition to the data inputted by the patient. Other potential input data streams include, but are not limited to, knowledge resources and interfaces with healthcare information systems. Possible examples of data from interfaces with healthcare information systems include prior enterprise care records, lab tests, medication lists, and care plans. Possible examples of knowledge resources include electronic textbooks, guidelines, and research articles.

Once the patient's data is received using the interactive patient module (250), the data enters the patient preference data repository (260). The patient preference data repository (260) stores the patient's data. For example, the patient's preferences can be recorded into the patient's permanent medical records. As another example, the patient preference data may be stored separately from their medical records and an association between the medical records and stored preference data may be made.

The patient preference system (220) can also integrate the patient's data with other healthcare information systems (230). The care providers (240) obtain the patient preferences and other data from the healthcare information systems. For example selected portions of the patient's preferences dealing with nursing care could be integrated into the nursing care plans. Similarly, selected portions of the patient's preferences could be integrated into the physicians orders or patient notes. The nurses and physicians could access the patient's preferences and other data through these sources. The integration enables more effective and customized nursing plans and provider decisions. More effective and customized care can lead to better outcomes for the patients (210).

The patient preference system (220) can also analyze the patient's data with data from other healthcare information systems (230). The combined analysis can organize and abstract the patient's preference data and other care-related data regarding the overall treatment and health of the patient. The patient preference system (220) can analyze the patient's data as a whole, using both the patient preference data and other data. Using this combined analyzed data, the provider can make better treatment and care decisions. In one example, the care provider (240) could use the analyzed data to see if incorporating a patient's preference into care decisions leads to increased patient satisfaction and improved clinical outcomes. In another example, the analyzed data could be used to determine which providers are delivering care to patients with the highest satisfaction. This would assist in abstracting the preference data into healthcare information systems that may be used for various purposes.

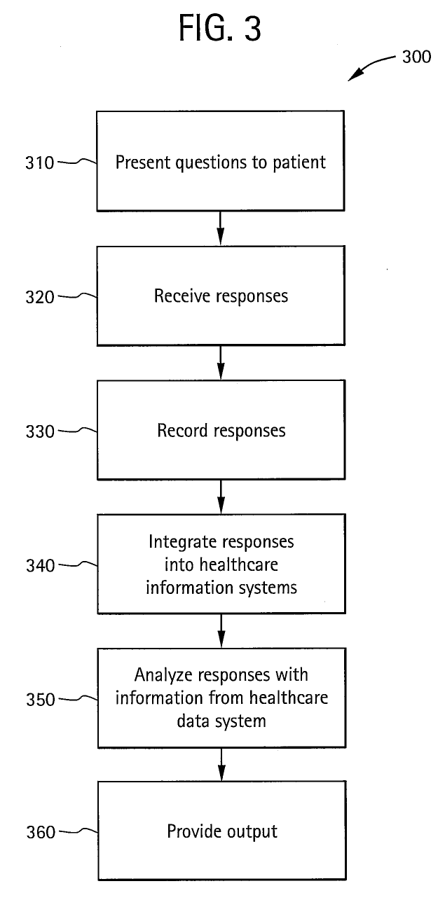

FIG. 3 illustrates a method (300) of managing patient preference data according to one embodiment of the present invention. The method (300) involves asking the patient questions (310), receiving the patient's responses (320), recording the patient's responses (330), integrating the responses into healthcare information systems (340) and analyzing the responses in light of other patient data (350), and providing output (360).

One or more of the steps of the method (300) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (300) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In order to provide better patient care patients are asked a series of questions (310). This may be done using an interactive patient module. The interactive patient module may be similar to (250) described above, for example.

The patient's responses to the questions are received and/or captured (320). The questions can involve care preferences including those related to quality of life, self-care capabilities, personal beliefs, and pain threshold.

The questions can be presented to the patient in a number of ways including, but not limited to, direct questions by a caregiver who enters them into the system, a written questionnaire to be entered into the system by the caregiver, a specialized website, a desktop, laptop or handheld computing device that is connected over the network to a healthcare information system, or a home computer using specialized software from the hospital. The questions can also take on numerous forms, such as short answer, fill in the blank, yes/no, true/false, multiple choice, Likert scale, or visual-analog scale.

The questioning can occur at numerous times before, during and after the patient's treatment. For example, the questions could be presented prior arriving at the healthcare facility, upon checking in, within a short time of checking in, upon checkout or when the patient returns for follow up appointments.

The patient can enter his or her responses using a keyboard, a touchscreen, a joystick, a mouse, a touchpad, a microphone or a similar input device.

The patient's responses are then recorded (330). They can be recorded into a patient preference repository. The patient preference repository may be similar to (260) described above, for example. The responses can be recorded using various recording devices and on various mediums. The patient's preferences may be recorded into the patient's permanent medical record. As another example, the patient preference data may be stored separately from their medical records and an association between the medical records and stored preference data may be made.

The patient's preference responses can also be integrated into healthcare information systems (340) in order to provide more individualized care for the patient. The healthcare information system may be similar to (230) described above, for example. The patient's responses can be integrated with nursing care plans, physician orders, notes, etc. This would allow the nurse, doctor or other healthcare provider to utilize both the patient's preference data and other relevant data when making important care and treatment decisions.

The patient's preference responses can also be analyzed (350) with other healthcare information systems. The healthcare information systems may be similar to (230) described above, for example. The data from the patient preference survey and data from other healthcare information systems can be examined in conjunction with each other to make healthcare determinations and decisions. In one example, the information can be analyzed to find if preference achievement leads to increased patient satisfaction and improved clinical outcomes. In another example, the analyzed data could be used to determine which providers are delivering care to patients with the highest satisfaction.

An output indicating patient preferences can then be provided to a care provider or healthcare administrator (360). This output could contain the recorded, integrated or analyzed data as discussed above. Other data could also be incorporated in with the output.

For example, the system can interview patients admitted for five days to an acute care unit for the elderly at a cancer hospital. This interview can be done electronically using an instrument with questions that can be answered on a Likert scale. At discharge, the patients are asked to review dimensions of their care that they had identified during the admission interview and rate their perceived achievement of those dimensions. When the patient returns for an outpatient visit, the system can again interview them on their ongoing treatment experience, quality of life, etc. The overall gathered data is abstracted and presented to the care providers when they interact with the hospital's enterprise healthcare system. The patient interview data is combined with lab results, medication data, problem lists, etc. This allows the caregiver to see the care priorities form the patient's perspective and how they change throughout treatment. Such information is very useful in determining treatment options, especially in chronic diseases state, terminal disease treatment, pain management etc. Based on this aggregated information view, the caregiver can respond by changing treatment as required. The nursing team can also use this information to prioritize nursing care.

In another example, a patient can enter health history data and preference information into a secure internet site prior to coming to the hospital. The information would be recorded into the patient's permanent records. This would make the check in process more speedy and convenient. It would also permit the care providers to begin utilizing the patient's personal preference data at the beginning of treatment.

Thus, certain embodiments provide the benefit of managing patient preference data. Certain embodiments also achieve the benefit of receiving, recording, integrating and analyzing patient preference in treatment decisions, potentially offering improved treatment and care.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

1. A method of managing patient preference data comprising:
presenting questions to a patient;
receiving responses from the patient wherein the responses indicate a preference of the patient; and
recording the responses to a repository wherein the recorded responses indicate a preference of the patient.

2. The method of claim 1 wherein the steps are performed sequentially.

3. The method of claim 1 further including integrating the responses that are applicable to a certain user into a specific healthcare information system utilized by that user.

4. The method of claim 3 wherein the certain user is a nurse and the specific healthcare information system generates nursing care plans.

5. The method of claim 3 wherein the certain care provider is a physician and the specific healthcare information system generates physician's orders.

6. The method of claim 1 further including analyzing the responses with data from at least one healthcare information system.

7. The method of claim 6 wherein the responses are analyzed to determine whether treatment based at least in part on patient preferences results in better clinical outcomes.

8. The method of claim 6 wherein the responses are analyzed to report data about a certain care provider's performance and patient satisfaction with the care provider's treatment.

9. The method of claim 1 wherein the responses are captured before the patient arrives at the healthcare facility for treatment.

10. The method of claim 1 wherein the responses are captured during the patient's treatment.

11. The method of claim 1 wherein the responses are captured after the patient's treatment.

12. A system for managing patient preference data comprising:
an interactive patient module adapted to receive patient preference data from a patient; and
a patient preference data repository adapted to record the patient preference data.

13. The system of claim 12 wherein the patient preference data is integrated into a healthcare information system along with other healthcare data from the healthcare information system.

14. The system of claim 12 wherein the patient preference data is analyzed with healthcare data from the healthcare information system.

15. The system of claim 14 wherein the analyzed data is utilized to provide individualized care.

16. The system of claim 12 wherein the interactive patient module is a website.

17. The system of claim 12 wherein the interactive patient module is a computing device connected over a network to a healthcare information system.

18. A computer-readable medium having a set of instructions for execution by a computer, the set of instruction comprising:
a questioning routine configured to obtain patient preference information from a patient;
a recording routine configured to record the patient preference information to a patient preference repository.

19. The computer-readable medium of claim 18 further comprising an integration routine configured to integrate the patient preference information with data from at least one healthcare information system.

20. The computer readable medium of claim 18 further comprising an analysis routine configured to analyze the patient preference information with data from at least one healthcare information system.
